(19) United States
(12) Patent Application Publication
(10) Pub. No.: US 2009/0327563 A1
(43) Pub. Date: Dec. 31, 2009

(54) CONNECTING BETWEEN DATA-HANDLING CIRCUITS OF AN INTEGRATED CIRCUIT

(76) Inventor: Ilia Greenblat, Kfar Saba (IL)

Correspondence Address: EMPK & Shiloh, LLP, c/o Landon IP Inc., 1700 Diagonal Road, Suite 450, Alexandria, VA, 22314, US

(21) Appl. No.: 12/164,283

(22) Filed: Jun. 30, 2008

(51) Int. Cl. G06F 13/40

(52) U.S. Cl. 710/305

(57) ABSTRACT

Device, system and method of connecting between data-handling circuits of an integrated circuit. For example, an integrated circuit includes a plurality of data-handling circuits; and a circuit-interconnect topology including at least one store-and-forward circuit along at least one connection path between at least a first and a second of the plurality of data-handling circuits. Other embodiments are described and claimed.

### FIELD

Some embodiments relate generally to the field of integrated circuits and, more particularly, to transferring data between a plurality of data-handling circuits of an integrated circuit.

### BACKGROUND

An integrated circuit, for example, a System on Chip (SoC), includes a plurality of hardware modules or circuits, which may be dedicated to specific and/or different tasks and/or operations. For example, the integrated circuit includes one or more processors, interfaces to external environments, memories, memory controllers, peripherals, and the like.

A typical bus oriented approach may be implemented to interconnect the plurality of hardware modules via a plurality of busses and bridges. Each bus may be implemented to connect between two or more of the hardware modules, and each bridge may be implemented to connect between two or more of the busses.

The bus-oriented approach may require debugging of a relatively large number of interfaces for both timing and logic. In addition, architectural decisions may need to be done early in design, since any modification, e.g., adding a peripheral or removing a processor may require considerable system modifications.

### SUMMARY

Some embodiments of the disclosed method and apparatus include, for example, devices, systems, and methods of connecting between data-handling circuits of an integrated circuit. In one embodiment, data-handling circuits communicate with one another through either a direct connection or through one or more store and forward (S&F) circuits. The connections between each data-handling circuit and each other data-handling circuit and the number of S&F circuits that lie between any two data-handling circuits are determined in order to take advantage of knowledge regarding the likely amounts of data that will be passed between particular data-handling circuits. The more data is likely to be passed between a first data-handling circuit and a second particular data-handling circuit, the more direct the connection between them (i.e., the fewer S&F circuits will be interposed between the first and second data-handling circuits).

Some embodiments include an integrated circuit including a plurality of data-handling circuits; and a circuit-interconnect topology including at least one store-and-forward circuit along at least one connection path between at least a first and a second of the plurality of data-handling circuits.

In some embodiments, the circuit-interconnect topology includes an asymmetric interconnect topology.

In some embodiments, the circuit-interconnect topology is based on data traffic patterns between the plurality of data-handling circuits.

In some embodiments, the data throughput between a first pair of data-handling circuits is higher than the data throughput between a second pair of data-handling circuits, and consequently, the number of store-and-forward circuits provided to transfer data between the second pair of data-handling circuits is larger than the number of store-and-forward circuits provided to transfer data between the first pair of data-handling circuits.

In some embodiments, a physical distance between a first pair of data-handling circuits is greater than a physical distance between a second pair of data-handling circuits, and consequently, the number of store-and-forward circuits provided to transfer data between the first pair of data-handling circuits is larger than the number of store-and-forward circuits to transfer data between the second pair of data-handling circuits.

In some embodiments, the circuit-interconnect topology connects at least one data-handling circuit of the plurality of data-handling circuits to all of the plurality of data-handling circuits.

In some embodiments, the circuit-interconnect topology connects each of the plurality of data-handling circuits to all of the plurality of data-handling circuits.

In some embodiments, the circuit-interconnect topology is to transfer data from outputs of a first group of the plurality of data-handling circuits to inputs of a second group of the plurality of data-handling circuits.

In some embodiments, the second group of data-handling circuits includes at least one data-handling circuit of the first group of data-handling circuits.

In some embodiments, the second group of data-handling circuits includes the first group of data-handling circuits.

In some embodiments, the circuit-interconnect topology transfers the data between the plurality of data-handling circuits based on a plurality of tags identifying addresses of the plurality of data-handling circuits and wherein the bit size of the tags depends upon the number of data-handling circuits for which addresses are to be identified.

In some embodiments, the plurality of data-handling circuits include at least one of a processor, a memory, a memory controller, a direct memory access module, a media-access-controller, an interface module, an input/output, and a peripheral module.

In some embodiments, the integrated circuit includes a system-on-chip.

In some embodiments, the system-on-chip includes a communication network gateway system-on-chip.

Some embodiments include a method of connecting a plurality of data-handling circuits of an integrated circuit, the method including transferring data between the plurality of data-handling circuits via a circuit-interconnect topology including at least one store-and-forward circuit along at least one connection path between at least a first and a second of the plurality of data-handling circuits.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system including an integrated circuit in accordance with some demonstrative embodiments;

FIG. 2 is a schematic block diagram illustration of a circuit-interconnect topology in accordance with some demonstrative embodiments;

FIG. 3 is a schematic block diagram illustration of a store and forward circuit in accordance with some demonstrative embodiments; and

FIG. 4 is a schematic flow-chart illustration of a method of connecting between data-handling circuits of an integrated circuit in accordance with some demonstrative embodiments.

### DETAILED DESCRIPTION

In the following detailed description, numerous specific details are set forth in order to provide a thorough understanding of some demonstrative embodiments of the disclosed method and apparatus. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data, which may be represented as physical (e.g., electronic) quantities within the computer's registers and/or memories, into other data, which may be similarly represented as physical quantities within the computer's registers and/or memories or within other information storage medium that may store instructions to perform operations and/or processes

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a server, a Personal Digital Assistant (PDA) device, a wireless communication device, a wireless Access Point (AP), a networking device, whether wired or wireless. It will be understood by those skilled in the art that this is a very brief list of the many, many devices in or with which the disclosed embodiments may be used.

Although not limited in this respect, the term “integrated circuit” (IC), as used herein refers to any suitable microcircuit, microchip, hybrid integrated circuit, digital integrated circuit and/or any other suitable electronic circuit, which includes, for example, a plurality of electronic devices manufactured in the surface of a thin substrate.

Although not limited in this respect, the term “system on chip” (SoC), as used herein refers to a single IC including a plurality of modules and/or components of a system, for example, a networking system or a communications system, e.g., a communication gateway, including, for example, substantially all the components needed for the system. The SoC includes digital, analog, mixed-signal, radio-frequency and/or any other suitable functions. In one embodiment, the SoC may include one or more controllers, processors, microcontrollers, microprocessors, Digital-Signal-Processing (DSP) cores; one or more memories; one or more timing sources, e.g., oscillators and/or phase locked loops; one or more peripherals, e.g., counter-timers or power-on reset generators; one or more external interfaces, e.g., a Universal Serial Bus (USB), an Ethernet interface, Universal Asynchronous Receiver-Transmitter (UART), a Serial Peripheral Interface (SPI), and the like; one or more analog interfaces; and/or any other suitable modules.

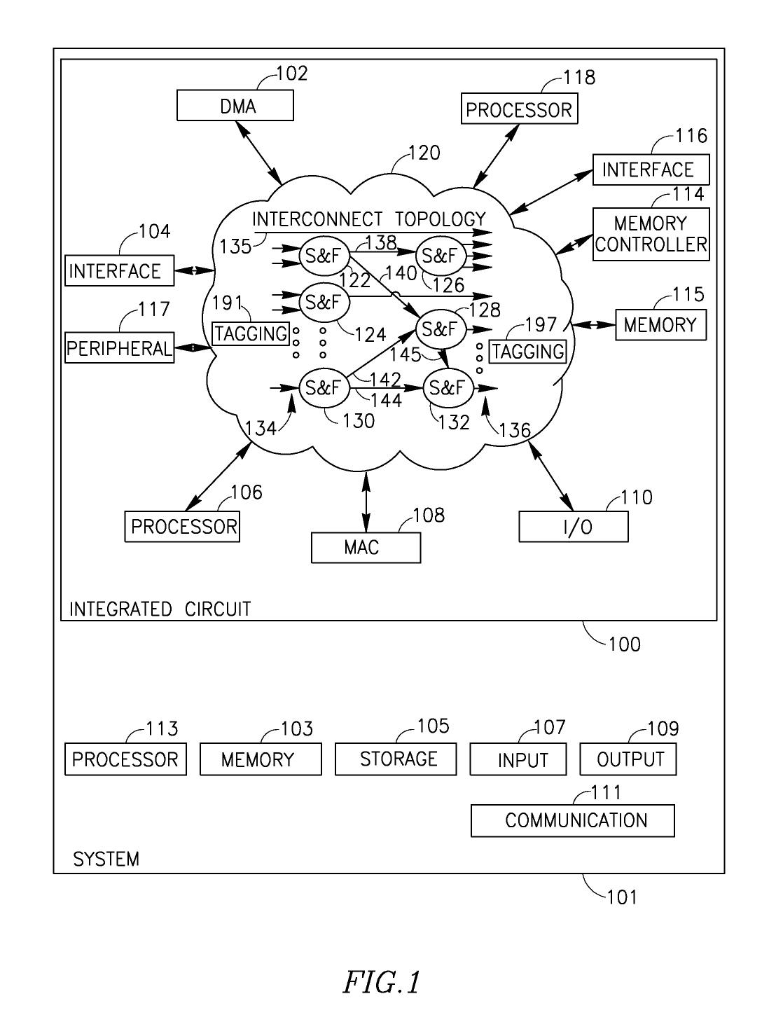

FIG. 1 is a block diagram that illustrates a system 101 including an IC 100. In some demonstrative embodiments, the IC 100 includes or is a SoC. In some embodiments, the IC 100 is implemented as part of a networking device. In one embodiment, the IC 100 includes or is a communication network gateway SoC, e.g., capable of converting protocols among communications networks, e.g., in accordance with the MoCA™ standard.

In some embodiments, the IC 100 includes a plurality of data-handling circuits, which includes any suitable circuits capable of using, processing, and/or storing data and/or performing one or more other operations on data. For example, the IC 100 includes, at least one processor, e.g., processors 106 and 118; at least one memory, e.g., memory 115; at least one memory controller, e.g., memory controller 114; at least one Direct-Memory-Access (DMA) module, e.g., DMA module 102; at least one Input-Output (I/O) module, e.g., I/O 110; at least one interface, e.g., interfaces 104 and 116; at least one Media-Access-Controller (MAC), e.g., MAC 108; at least one peripheral module, e.g., peripheral 117; and/or any other suitable data-handling circuits.

In some embodiments, the processors 106 and/or 118 include, for example, a central processing unit (CPU), a DSP, a microprocessor, a microcontroller, a controller, and/or any other suitable multi-purpose or specific processor or controller. The memory 115 includes, for example, a RAM, a ROM, a dynamic RAM (DRAM), a synchronous DRAM (SD-RAM), an EEPROM, a flash memory, or other suitable memory units or storage units.

In some embodiments, the IC 100 also includes at least one circuit-interconnect topology 120 to transfer data from outputs of a first group of two or more of the data-handling circuits 102, 118, 106, 115, 104, 116, 114, 108, 117, 110, to inputs of a second group of two or more of the data-handling circuits 102, 118, 106, 115, 104, 116, 114, 108, 117, 110, e.g., as described herein. The data route between a first data-handling circuit and a second data-handling circuit is referred to here as a “connection path”.

In some embodiments, the first and second groups include one or more common data-handling circuits, e.g., the second group of data-handling circuits includes at least one data-handling circuit of the first group of data-handling circuits.

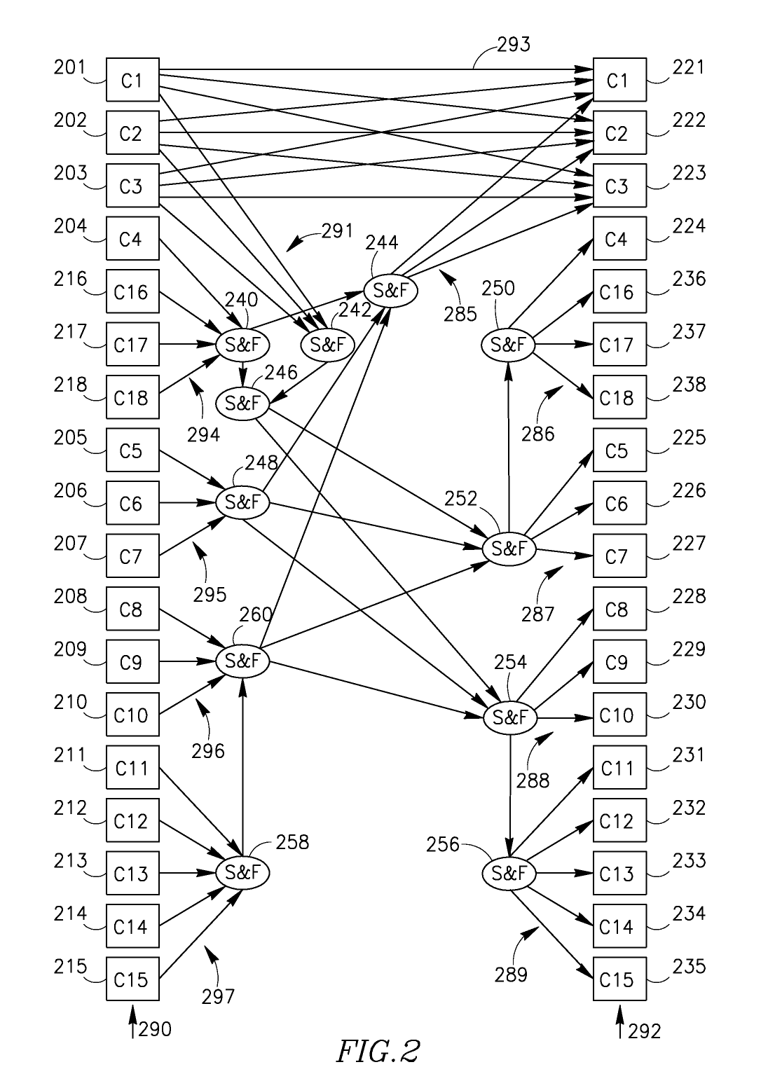

In some embodiments, the second group of data-handling circuits includes the first group of data-handling circuits and/or the first group of data-handling circuits includes the second group of data-handling circuits, e.g., as described below with reference to FIG. 2. In one embodiment, each of the first and second groups includes all of the data-handling circuits 102, 118, 106, 115, 104, 116, 114, 108, 117, and 110. In other embodiments, the first and/or second groups of data-handling circuits include one or more data-handling circuits not included in the second and/or first groups of data-handling circuits include one or more data-handling circuits, respectively.

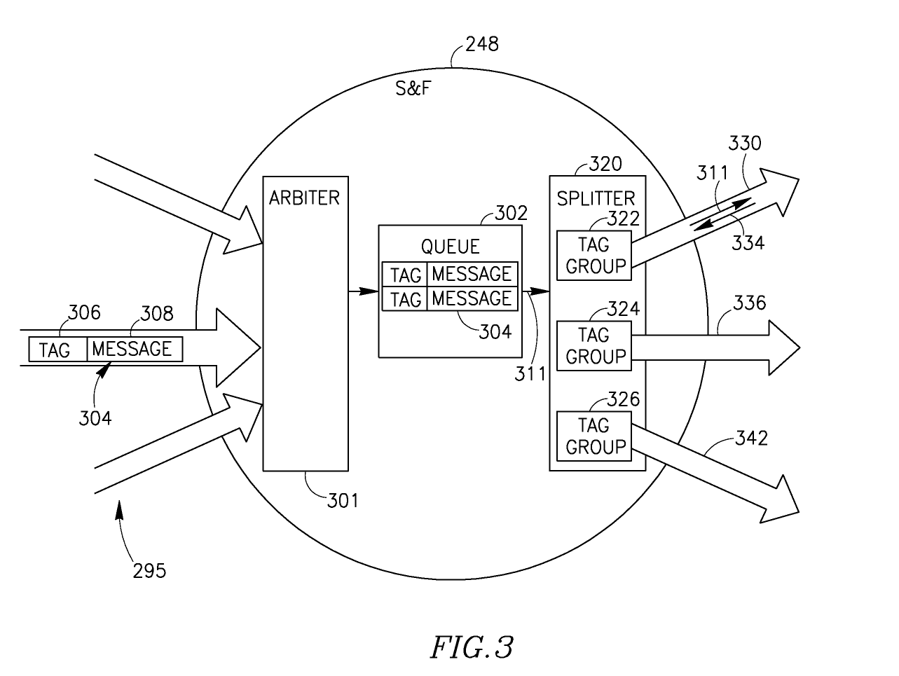

In some embodiments, the circuit-interconnect topology 120 includes a plurality of store-and-forward (S&F) circuits which lie along one or more connection paths, e.g., including at least S&F circuits 122, 124, 126, 128, 130 and 132, interconnecting between the plurality of data-handling circuits via a plurality of hardware connections, e.g., as described below. In one embodiment, the S&F circuits 122, 124, 126, 128, 130 and/or 132 include a S&F circuit as described below with reference to FIG. 3.

In some embodiments, the circuit-interconnect topology 120 includes: (a) a plurality of input hardware connections 134 to connect between outputs of the data-handling circuits and one or more of the S&F circuits 122, 124, 126, 128, 130 and 132; (b) a plurality of interconnect output hardware connections 136 to connect between one or more of the S&F circuits and inputs of the data-handling circuits; and (c) a plurality of intermediate hardware connections 138, 140, 142, 144, 145 which provide connections between selected S&F circuits, e.g., as described below.

In some embodiments, the circuit-interconnect topology 120 includes at least one direct hardware connection 135 to directly connect an output of at least one data-handling circuit to an input of at least one data-handling circuit. Direct connections 135 allow inputs of data-handling circuits to have direct access to outputs of data-handling circuits. In one embodiment, a first end of the direct connection 135 connects to either output of the DMA module 102, or the processor 118, or the processor 106, or the memory 115, or the interface 104, or the interface 116, or the memory controller 114, or the MAC 108, or the peripheral 117, or the I/O module 110. A second end of the direct connection 135 connects to an input of either the DMA module 102, or the processor 118, or the processor 106, or the memory 115, or the interface 104, or the interface 116, or the memory controller 114, or the MAC 108, or the peripheral 117, or the I/O module 110. In one embodiment, the direct connection 135 connects between an output and an input of two different data-handling circuits, e.g., between an output of processor 118 and an input of DMA module 102. It should be understood that in some embodiments, the direct connection 135 connects an output and an input of the same data-handling circuit, e.g., an output and input of processor 106 are directly connected in order to allow the processor 106 to directly transfer data generated by the processor 106 as input data back into the processor 106.

In some embodiments, each of the plurality of data-handling circuits has an output connected to the circuit-interconnect topology 120, e.g., via input connections 134 and/or direct connections 135, to provide data to be, transferred via the circuit-interconnect topology 120; and an input connected to the circuit-interconnect topology 120, e.g., via output connections 136 and/or direct connections 135, to receive data from the circuit-interconnect topology 120. In other embodiments, only some of the data-handling circuits have an output connected to the circuit-interconnect topology 120; and/or only some of the data-handling circuits have an input connected to circuit-interconnect topology 120. For example, the circuit-interconnect topology 120 provides a connection from the output of the DMA module 102, the processor 118, the processor 106, the memory 115, the interface 104, the interface 116, the memory controller 114, the MAC 108, the peripheral 117, and the I/O module 110 to the inputs of the DMA module 102, the processor 118, the processor 106, the memory 115, the interface 104, the interface 116, the memory controller 114, the MAC 108, the peripheral 117, and the I/O module 110. Alternatively, the circuit-interconnect topology 120 provides a connection from any suitable outputs of the plurality of data-handling circuits and any suitable inputs of the plurality of data-handling circuits. For example, in one embodiment, outputs of one or more of data-handling circuits 102, 118, 106, 115, 104, 116, 114, 108, 117, 110 are not be connected with inputs of one or more of data-handling circuits 102, 118, 106, 115, 104, 116, 114, 108, 117, 110.

In one embodiment, the S&F circuit 122 is connected to two of the input connections 134, e.g., to receive data from two of the data-handling circuits; and to the S&F circuits 126, 128 via the intermediate connections 138, 140, respectively, e.g., to provide the data from the S&F circuit 122 to the S&F circuit 126 and/or the S&F circuit 128. The S&F circuit 124 is connected to two other input connections 134, e.g., to receive data from two other data-handling circuits; and to an output connection 136, e.g., to provide a connection for the data received by S&F circuit 124 to be communicated to one of the data-handling circuits. The S&F circuit 130 is connected to another input connection 134, e.g., to receive data from a data-handling circuit. The S&F circuit 130 is also connected to the S&F circuits 128 and 132 via the intermediate connections 142, 144, respectively, e.g., to provide data from the S&F circuit 130 to the S&F circuits 128 and/or the S&F circuit 132. S&F circuit 126 is connected to three output connections 136, e.g., to provide the data received via connection 126 to three of the data-handling circuits, respectively. The S&F circuit 128 is connected to two other output connections 136, and to S&F circuit 132 via the intermediate connection 145, e.g., to provide the data received via connections 140, 142 to two other data-handling circuits and/or to the S&F circuit 132. S&F circuit 132 is connected to another output connection 136, e.g., to provide the data received via the intermediate connections 144, 145 to another data-handling circuit.

In some embodiments, the circuit-interconnect topology 120 is asymmetric. Alternatively, the topology is symmetrical. The topology is considered to be asymmetric if at least two “alternative” connections are made through a different number of S&F circuits. Connections are considered to be “alternative” if at least one of the endpoints differs. For example, the connection from the output of a first data-handling circuit to the input of a second data-handling circuit would be alternative to the connection from the output of a third data-handling circuit to the input of a fourth data-handling circuit. Another example is the connection from the output of a first data-handling circuit to the input of a second data-handling circuit is an alternative connection to the connection from the output of the second data-handling circuit to the input of the first data-handling circuit. In yet another example, the connection from the output of the first data-handling circuit to the input of the first data-handling circuit is alternative to the connection from the output of the first data-handling circuit to the input of a second data-handling circuit. Alternatively, the topology is considered to be symmetrical if the number of S&F circuits that lie along any one connection path is the same as the number of S&F circuits that lie along any other connection path in the topology.

In some embodiments, the circuit-interconnect topology 120 is based, at least in part, on how much data flows between each pair of data-handling circuits. In one embodiment, the data throughput between a first pair of data-handling circuits is higher than the data throughput between a second pair of data-handling circuits. In this case, the number of S&F circuits between the data-handling circuits of the first pair is preferably smaller than the number between the second pair, e.g., as described below with reference to FIG. 2. In another embodiment, a physical distance between the first pair of data-handling circuits is greater than a physical distance between the second pair of data-handling circuits. In this case, the number of S&F circuits between the first pair of data-handling circuits is preferably larger than the number of S&F circuits between the second pair of data-handling circuits, e.g., as described below with reference to FIG. 2. It should be understood that the criteria for determining the number of S&F circuits that lie between any two data-handling circuits can vary depending upon the particular tradeoffs to be made and results sought by the designer of the topology.

In some embodiments, the data-handling circuits are uniquely identified, e.g., each is associated with a unique address. The addresses are relatively long, for example, having a bit size of more than ten bits. In one embodiment, the address is twenty bits long.

In some embodiments, the circuit-interconnect topology 120 is capable of transferring data between the data-handling circuits based on a plurality of tags identifying the addresses of the data-handling circuits. The bit size of the tags is shorter than the bit size of the addresses. For example, the bit size of the tags depends upon the number of the data-handling circuits, denoted “m”. In one embodiment, the tags have a bit size equal to the integer between log₂(m) and log₂(m)+1.

In one embodiment, ten four-bit tags are assigned to identify ten data-handling circuits 102, 118, 106, 115, 104, 116, 114, 108, 117, 110, respectively, e.g., according to the following table:

TABLE 1

| Address | Tag | Circuit |
|---|---|---|
| xxxx xxxx xxxx xxxx xxxx | 0001 | DMA 102 |
| xxxx xxxx xxxx xxxx xxxx | 0010 | Processor 118 |
| xxxx xxxx xxxx xxxx xxxx | 0011 | Processor 106 |
| xxxx xxxx xxxx xxxx xxxx | 0100 | Memory 115 |
| xxxx xxxx xxxx xxxx xxxx | 0101 | Interface 104 |
| xxxx xxxx xxxx xxxx xxxx | 0110 | Interface116 |
| xxxx xxxx xxxx xxxx xxxx | 0111 | Memory controller 114 |
| xxxx xxxx xxxx xxxx xxxx | 1000 | MAC 108 |
| xxxx xxxx xxxx xxxx xxxx | 1001 | Peripheral117 |
| xxxx xxxx xxxx xxxx xxxx | 1010 | I/O 110 |

In some embodiments, the IC 100 includes at least one input-tagging module 191. The input tagging module 191 receives a message (“the original message”) from a data-handling circuit (“the origin circuit”). Upon receipt, the input tagging module 191 determines a tag by cross referencing the address of the circuit intended to receive the message (“the destination circuit”) to a tag using Table 1. The input tagging module 191 then generates a tagged message which includes the tag and the original message, e.g., as a payload. It will be understood by those skilled in the art in an alternative embodiment, such a table to cross reference the address of the destination circuit to a tag are not used. In such an embodiment, the input tagging module 191 performs a calculation to determine the tag by a hashing function or by some other such algorithm. In one embodiment, the hashing function or other such algorithm is based on the address of the destination circuit. In one such algorithm, the address is simply truncated, assuming that such truncation would result in a unique tag.

In some embodiments, the IC 100 includes at least one output-tagging module 197 to receive the tagged message via the circuit-interconnect topology 120. The output-tagging module 197 determines the destination circuit based on the tag and generates the original message by removing the tag from the tagged message.

In one embodiment, the IC 100 includes a plurality of input tagging modules 191, each associated with one or more of the outputs of the data-handling circuits, respectively; and/or a plurality of output tagging modules 197, each associated with one or more of the outputs of the data-handling circuits, respectively.

In some embodiments, the tagging modules 191, 197 are implemented, for example, as part of the circuit-interconnect topology 120. Alternatively, the tagging modules 101, 197 are implemented as part of one or more of the data-handling circuits 102, 118, 106, 115, 104, 116, 114, 108, 117, and 110.

Although in some embodiments the tagging modules 191, 197 are implemented as separate modules of the IC 100, in other embodiments the IC 100 includes a single tagging module capable of performing the functions of both the input-tagging modules 191 and the output-tagging module 197.

In some embodiments, the system 100 includes or is any suitable computing, communication and/or networking system. In one embodiment, the system 100 includes a processor 113, a memory unit 103, a storage unit 105, an input unit 107, an output unit 109, a communication unit 111, and/or any suitable hardware and/or software units or devices. The processor 113 includes, for example, a central processing unit (CPU), a DSP, a microprocessor, a controller, a host processor, a plurality of processors or controllers, or any other suitable multi-purpose or specific processor or controller. The memory unit 103 includes, for example, a RAM, a ROM, a DRAM, a SD-RAM, a flash memory, a volatile memory, a non-volatile memory, a cache memory, a buffer, a short term memory unit, a long term memory unit, or other suitable memory units or storage units. The storage unit 105 includes, for example, a hard disk drive, a floppy disk drive, a compact disk (CD) drive, a CD-ROM drive, a digital versatile disk (DVD) drive, or other suitable removable or non-removable storage emits. The input unit 107 includes, for example, a keyboard, a keypad, a mouse, a touch-pad, a stylus, a microphone, or other suitable pointing device or input device. The output unit 109 includes, for example, a cathode ray tube (CRT) monitor or display unit, a liquid crystal display (LCD) monitor or display unit, a screen, a monitor, a speaker, or other suitable display unit or output device. The communication unit 111 includes, for example, a network interface card (NIC), a modem, a receiver and/or transmitter, a transmitter-receiver and/or transceiver, a radio frequency (RF) communication unit or transceiver, or other units able to transmit and/or receive communications over a communication network. Such devices can be either wired or wireless.

In some embodiments, one or more of the data-handling circuits of the IC 100, such as interface 104, interface 116, and/or I/O module 110, are capable of communicating with the IC 100 and the processor 113, the memory 103, the storage 105, the input 107, the output 109, and/or the communication unit 111, to transfer data between the IC 100 and the processor 113, the memory 103, the storage 105, the input 107, the output 109, and/or the communication unit 111.

It will be understood by those skilled in the art that the configuration and/or arrangement of the S&F circuits of the circuit-interconnect topology 120 is flexible to allow the design to accommodate changes in the amount of data that is anticipated to flow between the data-handling circuits. For example, the circuit-interconnect topology 120 may be efficiently and/or simply modified and/or adapted by rearranging, adding and/or deleting the hardware connections and/or S&F circuits. This further accommodates any modification of the IC 100, for example, modification of the configuration and/or arrangement of one or more of data-handling circuits 102, 118, 116, 114, 115, 110, 108, 106, 117, 104; adding one or more other data-handling circuits; and/or removing one or more of data-handling circuits 102, 118, 116, 114, 115, 110, 108, 106, 117, 104. Accordingly, implementing the disclosed circuit-interconnect topology 120 enables and/or simplifies the making of architectural decisions and/or performing modifications to the IC 100 at relatively late stages in the design of the IC 100.

FIG. 2 is a schematic of a circuit-interconnect topology 200. It should be understood that the circuit-interconnect topology 200 shown in FIG. 2 is merely one embodiment. Several alternative embodiments are possible without departing from the concept being disclosed herein. In the embodiment shown in FIG. 2, the circuit-interconnect topology 200 connects a first and second group 290, 292, of eighteen data-handling circuits c1, c2, c3, c4, c5, c6, c7, c8, c9, c10, c11, c12, c13, c14, c15, c16, c17, and c18.

The group 290 includes eighteen outputs 201, 202, 203, 204, 205, 206, 207, 208, 209, 210, 211, 212, 213, 214, 215, 216, 217, 218 of eighteen data-handling circuits c1, c2, c3, c4, c5, c6, c7, c8, c9, c10, c11, c12, c13, c14, c15, c16, c17, c18, respectively. Group 292 includes eighteen inputs 221, 222, 223, 224, 225, 226, 227, 228, 229, 230, 231, 232, 233, 234, 235, 236, 237, 238 of eighteen data-handling circuits c1, c2, c3, c4, c5, c6, c7, c8, c9, c10, c11, c12, c13, c14, c15, c16, c17, c18, respectively.

The circuit-interconnect topology 200 provides a connection between the outputs 201, 202, 203, 204, 205, 206, 207, 208, 209, 210, 211, 212, 213, 214, 215, 216, 217, 218 and the inputs 221, 222, 223, 224, 225, 226, 227, 228, 229, 230, 231, 232, 233, 234, 235, 236, 237, 238 as described below. The circuit-interconnect topology 200 includes a plurality of direct hardware connections 293 to connect the outputs of group 290 to the inputs of group 292. Three direct hardware connections 293 are shown to directly connect the output 201 of circuit c1 to the inputs 221, 222, 223 of the circuits c1-c3. Another three direct hardware connections 293 directly connect the output 202 of the circuit c2 with the inputs 221, 222, 223 of the circuits c1-c3. Three more direct hardware connections 293 provide a direct connection from the output 203 of the circuit c3 to the inputs 221, 222, 223 of the three circuits c1-c3.

The circuit-interconnect topology 200 also includes five S&F circuits 242, 240, 248, 260, 258 that are each connected directly to several of the outputs 201-218 of the data-handling circuits c1-c18. In the embodiment shown in FIG. 2, each output 201-218 is connected to one of the five S&F circuits via a respective one of the hardware connections 291, 294, 295, 296, 297. The S&F circuit 242 is connected to three outputs 201, 202, 203 via three hardware connections 291. The S&F circuit 240 is connected to four outputs 204, 216, 217, 218 via four hardware connections 294. The S&F circuit 248 is connected to three outputs 205, 206, 207 via three input hardware connections 295. The S&F circuit 260 is connected to three outputs 208, 209, 210 via three input hardware connections 296. The S&F circuit 258 is connected to five outputs 211, 212, 213, 214, 215 via five input hardware connections 297. In an alternative embodiment, the same output 201-218 is connected to more than one of the S&F circuits 242, 240, 248, 260, 258. It will be understood that alternative embodiments may have either a greater or a lesser number of S&F circuits than are shown in the embodiment of FIG. 2.

In the embodiment shown in FIG. 2, five S&F circuits 244, 250, 252, 254, 256 are directly connected to inputs 221-238 of the data-handling circuits c1-c18 via several hardware connections 285-289. The S&F circuit 244 is connected to three inputs 221, 222, 223 via three output hardware connections 285. The S&F circuit 250 is connected to four inputs 224, 236, 237, 238 via four output hardware connections 286. The S&F circuit 252 is connected to three inputs 225, 226, 227 via three output hardware connections 287. The S&F circuit 254 is connected to three inputs 228, 229, 230 via three output hardware connections 288. The S&F circuit 256 is connected to five inputs 231, 232, 233, 234, 235 via five output hardware connections 289. In an alternative embodiment, the connections to the inputs 221-238 can be made to a greater or lesser number of S&F circuits. In addition, in this or another alternative embodiment, more than one S&F circuit is connected to a particular input 221-238.

In the embodiment shown in FIG. 2, some of the S&F circuits 240, 242, 248, 258, 260 that are connected to the outputs 201-218 of the data-handling circuits c1-c18 are also connected to one or more of the S&F circuits 244, 250, 252, 254, 256 that are connected to the inputs 221-238 of the data-handling circuits c1-c18. For example, the S&F circuit 244 is connected to three S&F circuits 240, 248, 260 via three hardware connections. The S&F circuit 250 is connected to the S&F circuit 252 via a hardware connection. The S&F circuit 252 is connected to three S&F circuits 246, 248, 260 via three hardware connections. The S&F circuit 254 is connected to three S&F circuits 246, 248, 260 via three hardware connections. The S&F circuit 256 is connected to the S&F circuit 254 via a hardware connection. There is one S&F circuit 246, which is connected only to other S&F circuits 240, 242, 252, 254.

Accordingly, data output by one of the data-handling circuits, for example through the output 201 of the data-handling circuit c1, will be available to the inputs of that and other data-handling circuits, for example, the inputs 221-223 of the data-handling circuits c1-c3 directly through the direct input connections 293. In addition, data output from the data-handling circuit c1 will be available to the data-handling circuit c4 via the input 224 over a connection between the S&F circuit 242, which is connected to the S&F circuit 246, which is connected to the S&F circuit 252, which is connected to the input 224. As can be seen this path requires the data to traverse several S&F circuits 242, 246, 252. Accordingly, such a configuration would be appropriate where such a path between the output of the data-handling circuit c1 and the input of the data-handling circuit c4 is either used infrequently or is a very low priority path, and/or if circuits c1 and c4 are physically distant from one another. Tracing the circuit shown in FIG. 2 indicates that the data that enters the circuit-interconnect topology 200 from the data-handling circuit c1 through output 201 can be routed through combinations of the S&F circuits 242, 246, 250, 252, 254, 256 to any of the input circuits 224-238.

In fact, in the embodiment shown in FIG. 2, the circuit-interconnect topology 200 is capable of connecting the output of each of the data-handling circuits c1-c18 to the inputs of each of the data-handling circuits c1-c18.

In some embodiments, an output of outputs 201, 202, 203, 204, 205, 206, 207, 208, 209, 210, 211, 212, 213, 214, 215, 216, 217, 218 of the data-handling circuits c1-c18 may be connected to an input of inputs 221, 222, 223, 224, 225, 226, 227, 228, 229, 230, 231, 232, 233, 234, 235, 236, 237, 238 of those data-handling circuits via no more than a single hardware path of the circuit-interconnect topology 200.

In some embodiments, the circuit-interconnect topology 200 is asymmetric. In an asymmetric circuit-interconnect topology the number of store-and-forward circuits that lie in the path between a first data-handling circuit and a second data-handling circuit will be different from the number of such S&F circuits that lie in the path between the first data-handling circuit and a third data-handling circuit. For example, as shown in FIG. 2, circuit-interconnect topology 200 may directly connect a first data-handling circuit (e.g., circuit c1) and a second data-handling circuit (e.g., circuit c2). However, the connection from the output of the first data-handling circuit c1 to the input of a third data-handling circuit (e.g., circuit c8) will require the data to traverse three S&F circuits 242, 246, 254. Note that in the embodiment shown in FIG. 2, the connection in the reverse direction from the output of the data-handling circuit c8 to the input of the data-handling circuit c1 requires the data to traverse only two S&F circuits 260, 244. Accordingly, the number of S&F circuits that lie between any two circuits c1-c18 depends not only on the particular circuits, but also on the direction of the data flowing between those two circuits.

In some embodiments, the circuit-interconnect topology 200 may be based on a data traffic pattern, e.g., an intended, evaluated, expected and/or simulated data traffic pattern, between the particular group of data-handling circuits c1, c2, c3, c4, c5, c6, c7, c8, c9, c10, c11, c12, c13, c14, c15, c16, c17, c18 at issue. Data traffic patterns are a measure of the amount of data that flows from one point to another point in the system and/or the frequency of such data flow.

In some embodiments, an intended, evaluated, expected and/or simulated data throughput (“the data throughput”) from the output of a first data-handling circuit (e.g., the output 201 of the circuit c1) to the input of a second data-handling circuit (e.g., the input 222 of the circuit c2) may be higher than the data throughput from the output of a third data-handling circuit (e.g., the output 208 of the circuit c8) to the input of a fourth data-handling circuit (e.g., the input 230 of the circuit c10). Accordingly, in one embodiment, the path between the output 201 of the first data-handling circuit c1 and the input 222 of the second data-handling circuit c2 should be more direct (or at least no less direct), (i.e., through the same number or less S&F circuits), than the path from the output 208 of the third data-handling circuit c8 to the input 230 of the fourth data-handling circuit c10.

Typically, the physical distance between pairs of data-handling circuits will differ. In one embodiment, the difference in the distance between data-handling circuits will be used as a parameter in determining the number of S&F circuits that will lie between each pair of data-handling circuits. In one embodiment, the longer the distance, the more S&F circuits will lie in the path.

FIG. 3 schematically illustrates the S&F circuit 248 shown in FIG. 2, in accordance with some embodiments.

In the embodiment shown in FIG. 3, the S&F circuit 248 is connected to the three circuits c5-7 shown in FIG. 2, via the three hardware connections 295. The S&F circuit 248 is connected to the S&F circuits 244, 252, 254 shown in FIG. 2 via three intermediate hardware connections 330, 336, 342, respectively. Accordingly, hardware connection 330 is associated with a first group 322 of the destination circuits c1, c2, and c3 shown in FIG. 2; hardware connection 336 is associated with a second group 324 of the destination circuits c4, c16, c17, c18, c5, c6, and c7 shown in FIG. 2; and hardware connection 342 is associated with a third group 326 of the destination circuits c8, c9, c10, c11, c12, c13, c14 and c15 shown in FIG. 2.

In some embodiments, the S&F circuit 248 includes a queue 302. The queue 302 includes any suitable memory and/or buffer and maintains a plurality of tagged messages according to a first-in-first-out (FIFO) scheme or any other suitable scheme for recovering the tagged messages. In one embodiment, the S&F circuit 248 includes an arbiter 301 to receive via the hardware connections 295 one or more tagged messages 304, which include a message 308 and a tag 306 identifying the destination of the message 308, e.g., as described above. The arbiter 301 provides the tagged messages 302 to the queue 302 according to a predefined arbitration scheme, e.g., a round robin arbitration scheme or any other suitable arbitration scheme. In one embodiment, the arbiter 301 transfers an acknowledgment message on the hardware connection 295 through which the tagged message 304 was received, e.g., upon storing the tagged message 304 in the queue 302. The arbiter 301 transfers a non-accept signal to the circuits connected to hardware connections 295 if, for example, the queue 302 is full.

In some embodiments, the queue 302 maintains the message 304 as part of a queue of messages. Alternatively, the message 304 is maintained in any other manner that allows the message to be recovered for forwarding. In accordance with the FIFO scheme, the queue 302 generates an output message 311 by selecting from the queue and incorporating into the message 311, the message 310 that was received least recently. The generated message 311 is then sent out of the queue 302.

In some embodiments, the S&F circuit 248 includes a splitter 320. The splitter 320 is capable of selectively forwarding the message 311 via a selected hardware connection from among the hardware connections 330, 336, 342. The tag of message 311 indicates which particular hardware connection is to be selected. Alternatively, the message 311 may be routed via other information either contained within the message 311 or known to the splitter 320.

In one embodiment, the splitter 320 determines which group of destination data-handling circuits is associated with the tag of the message 311. Tagged messages 311, which have a tag associated with the first group of destination data-handling circuits, are sent out over hardware connection 330. Tagged messages 311 having a tag associated with the second group of destination data-handling circuits are sent out over hardware connection 336. Likewise, tagged messages 311 having a tag associated with the third group of destination data-handling circuits are sent out over hardware connection 342.

In some embodiments, the splitter 320 receives acknowledgment messages 334 via connections 330, 336 and/or 342. The acknowledgement messages 334 acknowledge the receipt of tagged messages 311 by the S&F circuits 244, 252 and 254, respectively.

In some embodiments, the splitter 320 removes the message 310 from the queue 302, for example, upon receiving the acknowledgement message 334 corresponding to the message 310.

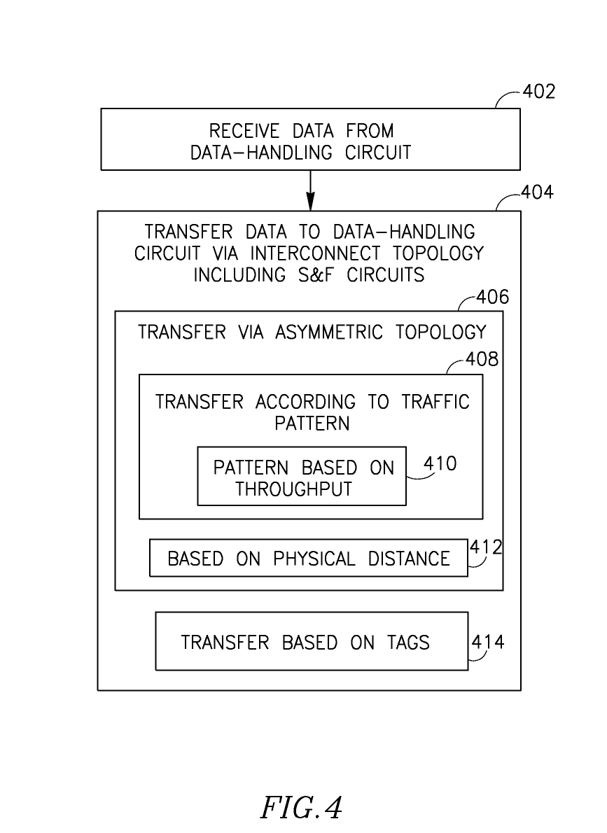

FIG. 4 schematically illustrates a method of connecting data-handling circuits of an integrated circuit. In some embodiments one or more operations of the method of FIG. 4 may be performed by one or more elements of the IC 100 shown in FIG. 1, e.g., the circuit-interconnect topology 120 shown in FIG. 1, and/or the circuit-interconnect topology 200 shown in FIG. 2 to connect the data-handling circuits.

As indicated at block 402, the method includes receiving data from one or more of the data-handling circuits. For example, the circuit-interconnect 120 may receive the data via one or more of the input hardware connections 134, e.g., as described above with reference to FIG. 1.

As indicated at block 404, the method includes transferring the data to one or more circuits of the data-handling circuits via a circuit-interconnect topology including a plurality of S&F circuits, which connect the data-handling circuits via a plurality of hardware connections. For example, the circuit-interconnect topology 120 may transfer the data to one or more of the data-handling circuits, e.g., as described above with reference to FIG. 1. The data-handling circuits include, for example, at least one of a processor, a memory, a memory controller, a direct memory access module, a media-access-controller, an interface module, an input/output, and a peripheral module, e.g., as described above. In one embodiment, the circuit-interconnect topology may connect, for example, at least one data-handling circuit of the plurality data-handling circuits and all of the data-handling circuits, e.g., as described above. In one embodiment, the circuit-interconnect topology may connect, for example, each of the data-handling circuits and all of the data-handling circuits, e.g., as described above. In one embodiment, transferring the data via the circuit-interconnect topology includes transferring data from outputs of a first plurality of data-handling circuits to inputs of a second plurality of data-handling circuits, e.g., as described above. The second plurality of data-handling circuits include, for example, at least one data-handling circuit of the first plurality of data-handling circuits, e.g., as described above. For example, the second plurality of data-handling circuits include the first plurality of data-handling circuits, e.g., as described above.

As indicated at block 406, transferring the data via the circuit-interconnect topology includes transferring the data via an asymmetric interconnect topology, in which first and second pairs of data-handling circuits of the data-handling circuits are interconnected via first and second different numbers of S&F circuits, respectively. For example, the circuit-interconnect topology 120 as shown in FIG. 1 includes an asymmetric topology, e.g., as described above.

As indicated at block 408, transferring the data via the circuit-interconnect topology includes transferring the data based on the data traffic pattern between the data-handling circuits. For example, the circuit-interconnect topology 200 as shown in FIG. 2 is based on the data traffic pattern between the data-handling circuits, e.g., as described above.

As indicated at block 410, the second number may be larger than the first number, and transferring the data via the circuit-interconnect topology includes transferring data between the first pair of data-handling circuits at a data throughput higher than the data throughput between the second pair of data-handling circuits. For example, the data throughput between data-handling circuits c1 and c2 may be higher than the data throughput between data-handling circuits c8 and c10, e.g., as described above with reference to FIG. 2.

As indicated at block 412, a physical distance between the first pair of data-handling circuits is greater than a physical distance between the second pair of data-handling circuits, and wherein the first number is larger than the second number. For example, the physical distance between data-handling circuits c8 and c10 may be greater than the physical distance between data-handling circuits c1 and c2, e.g., as described above with reference to FIG. 2.

As indicated at block 414, transferring the data via the circuit-interconnect topology includes transferring the data between the data-handling circuits based on a plurality of tags identifying addresses of the data-handling circuits, respectively. In one embodiment, the bit size of the tags depends upon the number of the data-handling circuits. For example, the S&F circuits may transfer the data based on tags assigned by tagging module 191, e.g., as described above with reference to FIG. 1.

Some portions of the disclosed apparatus are entirely embodied in hardware. Other portions are entirely embodied in software, which includes but is not limited to firmware, resident software, microcode, or the like. Still other portions include both hardware and software elements.

Furthermore, some portions of the disclosed apparatus take the form of a computer-usable or computer-readable medium providing program code for use by or in connection with a computer or any instruction execution system. A computer-usable or computer-readable medium is or includes anything that can contain, store, communicate, propagate, or transport the program for use by or in connection with an instruction execution system, apparatus, or device.

Some examples of a computer-readable medium include a propagation medium, an electronic, magnetic, optical, electromagnetic, infrared, or semiconductor system (or apparatus' or device). Some such systems include (or are) a semiconductor or solid state memory, magnetic tape, a removable computer diskette, a random access memory (RAM), a read-only memory (ROM), a rigid magnetic disk, and an optical disk. Some examples of optical disks include compact disk-read only memory (CD-ROM), compact disk-read/write (CD-R/W), and DVD. In

In some embodiments, a data processing system suitable for storing and/or executing program code includes at least one processor coupled directly or indirectly to memory elements, for example, through a system bus. The memory elements include, for example, local memory employed during actual execution of the program code, bulk storage, and cache memories which may provide temporary storage of at least some program code in order to reduce the number of times code must be retrieved from bulk storage during execution.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. An integrated circuit comprising:
a plurality of data-handling circuits; and
a circuit-interconnect topology comprising at least one store-and-forward circuit along at least one connection path between at least a first and a second of the plurality of data-handling circuits.

2. The integrated circuit of claim 1, wherein the circuit-interconnect topology comprises an asymmetric interconnect topology.

3. The integrated circuit of claim 2, wherein the circuit-interconnect topology is based on data traffic patterns between the plurality of data-handling circuits.

4. The integrated circuit of claim 3, wherein the data throughput between a first pair of data-handling circuits is higher than the data throughput between a second pair of data-handling circuits, and consequently, the number of store-and-forward circuits provided to transfer data between the second pair of data-handling circuits is larger than the number of store-and-forward circuits provided to transfer data between the first pair of data-handling circuits.

5. The integrated circuit of claim 2, wherein a physical distance between a first pair of data-handling circuits is greater than a physical distance between a second pair of data-handling circuits, and consequently, the number of store-and-forward circuits provided to transfer data between the first pair of data-handling circuits is larger than the number of store-and-forward circuits to transfer data between the second pair of data-handling circuits.

6. The integrated circuit of claim 1, wherein the circuit-interconnect topology connects at least one data-handling circuit of the plurality of data-handling circuits to all of the plurality of data-handling circuits.

7. The integrated circuit of claim 6, wherein the circuit-interconnect topology connects each of the plurality of data-handling circuits to all of the plurality of data-handling circuits.

8. The integrated circuit of claim 1, wherein the circuit-interconnect topology is to transfer data from outputs of a first group of the plurality of data-handling circuits to inputs of a second group of the plurality of data-handling circuits.

9. The integrated circuit of claim 8, wherein the second group of data-handling circuits includes at least one data-handling circuit of the first group of data-handling circuits.

10. The integrated circuit of claim 9, wherein the second group of data-handling circuits includes the first group of data-handling circuits.

11. The integrated circuit of claim 1, wherein the circuit-interconnect topology transfers the data between the plurality of data-handling circuits based on a plurality of tags identifying addresses of the plurality of data-handling circuits and wherein the bit size of the tags depends upon the number of data-handling circuits for which addresses are to be identified.

12. The integrated circuit of claim 1, wherein the plurality of data-handling circuits include at least one module selected from the group consisting of a processor, a memory, a memory controller, a direct memory access module, a media-access-controller, an interface module, an input/output, and a peripheral module.

13. The integrated circuit of claim 1 comprising a system-on-chip.

14. The integrated circuit of claim 13, wherein the system-on-chip comprises a communication network gateway system-on-chip.

15. A method of connecting a plurality of data-handling circuits of an integrated circuit, the method comprising:
transferring data between the plurality of data-handling circuits via a circuit-interconnect topology comprising at least one store-and-forward circuit along at least one connection path between at least a first and a second of the plurality of data-handling circuits.

16. The method of claim 15, wherein transferring the data via the circuit-interconnect topology comprises transferring the data via an asymmetric interconnect topology.

17. The method of claim 16, wherein the number of store-and-forward circuits between a first pair of the data-handling circuits depends upon the data traffic pattern between the first pair of data-handling circuits.

18. The method of claim 17, wherein the number of store-and-forward circuits between the first pair of data-handling circuits is smaller than the number of store-and-forward circuits between a second pair of data-handling circuits, and wherein transferring the data via the circuit-interconnect topology comprises transferring more data between the first pair of data-handling circuits than between the second pair of data-handling circuits.

19. The method of claim 16, wherein a physical distance between a first pair of data-handling circuits is greater than a physical distance between a second pair of data-handling circuits, and wherein the number of store-and-forward circuits between the data-handling circuits of the first pair is larger than the number of store-and-forward circuits between the data-handling circuits of the second pair.

20. The method of claim 15, wherein the circuit-interconnect topology connects at least one data-handling circuit of the plurality data-handling circuits to all of the plurality of data-handling circuits.

21. The method of claim 20, wherein the circuit-interconnect topology connects between each of the plurality of data-handling circuits and all of the plurality of data-handling circuits.

22. The method of claim 15, wherein transferring the data via the circuit-interconnect topology comprises transferring data from outputs of a first group of the plurality of data-handling circuits to inputs of a second group of the plurality of data-handling circuits.

23. The method of claim 22, wherein the second group of data-handling circuits includes at least one data-handling circuit of the first group of data-handling circuits.

24. The method of claim 23, wherein the second group of data-handling circuits includes the first group of data-handling circuits.

25. The method of claim 15, wherein transferring the data via the circuit-interconnect topology comprises transferring the data between the plurality of data-handling circuits based on a plurality of tags identifying addresses of the plurality of data-handling circuits and wherein a bit size of the tags depends upon the number of data-handling circuits for which addresses are to be identified.

26. The method of claim 15, wherein the plurality of data-handling circuits include at least one module selected from the group consisting of a processor, a memory, a memory controller, a direct memory access module, a media-access-controller, an interface module, an input/output, and a peripheral module.
